(19) United States
(12) Patent Application Publication
(10) Pub. No.: US 2026/0158413 A1
(43) Pub. Date: Jun. 11, 2026

(54) AUTOMATED SELF-OPTIMIZATION OF CONTINUOUS CRYSTALLIZATION

(71) Applicant: Pfizer Inc., New York, NY (US)

(72) Inventors: Kevin Paul Girard, Quaker Hill, CT (US); Steven Matthew Guinness, Colchester, CT (US); Kakasaheb Yankappa Nandiwale, Groton, CT (US)

(73) Assignee: Pfizer Inc., New York, NY (US)

(21) Appl. No.: 19/127,264

(22) PCT Filed: Nov. 6, 2023
(86) PCT No.: PCT/IB2023/061172

§ 371 Date: May 5, 2025

Related U.S. Application Data
(60) Provisional application No. 63/382,806, filed on Nov. 8, 2022.

(51) Int. Cl. B01D 9/00; G05B 13/02

(52) U.S. Cl. CPC B01D 9/0063; B01D 9/0054; B01D 9/0081; G05B 13/0265; B01D 2009/0086

(57) ABSTRACT

Technology is disclosed for a method for performing crystallization, where the method may include utilizing a software algorithm, and perform a crystallization process using the software algorithm.

### BACKGROUND OF THE INVENTION

Continuous flow crystallization can be an attractive mode of operation, due to its ability to generate consistent product quality while requiring only a smaller footprint and lower production costs than its batch counterpart. It can also offer the ability to operate in kinetic regimes and helps to achieve particle outcomes including size and shape that are not easily achievable using batch technology.

However, the design and optimization of continuous processes can be both labor intensive and costly, since the smallest scales of operation can consume a large amount of material and requiring a lot of time to reach steady state operation. Human intervention for sampling, process parameter manipulation, and decision making can also require significant numbers of man-hours to reach a perceived optimum, which may not coincide with the true, mathematical optimum. Further, experimentation is often performed in a one-factor-at-a-time approach, which is less efficient that DOE-based approaches. As such, there exists a need for crystallization methods that's time efficient but also provides good yield.

### SUMMARY OF THE INVENTION

This summary is provided to introduce a selection of concepts in a simplified form that is further described below in the detailed description. This summary is neither intended to identify key features or essential features of the claimed subject matter nor to be used in isolation as an aid in determining the scope of the claimed subject matter.

Embodiments of the technologies described in the present disclosure enables a method for performing crystallization, where the method may include utilizing a software algorithm, and performing a crystallization process using the software algorithm.

In some embodiments, the software algorithm may be a machine learning algorithm, or an artificial intelligence (AI) algorithm. In some other embodiments, the software algorithm may be a mixed-integer nonlinear programming (MINLP). In yet another embodiment, the MINLP algorithm may be based on optimal design of experiments (DoE) and adaptive response surface methodology (ARSM).

In yet another embodiment, the crystallization process can be configured to optimizing process temperature. In another embodiment, the crystallization process may be configured to optimize sonication power, residence time, or antisolvent addition profile. In yet another embodiment, the crystallization process may be configured to optimize process yield, product purity, particle size, or particle shape.

In another embodiment, the subject matter presented herein includes a crystallization system including means to utilizing a software algorithm, means to perform a crystallization process using the software algorithm, means to collect data from the crystallization process, and means to perform additional crystallization process using the collected data.

### BRIEF DESCRIPTION OF THE DRAWING

Aspects of the disclosure are described in detail below with reference to the attached figures, wherein:

FIG. 1 illustrates a block diagram of an exemplary strategy for automated self-optimization in accordance with the subject matter presented herein;

FIG. 2 illustrates a flow chart of an optimization algorithm performing DoEs in accordance with the subject matter presented herein;

FIG. 3 illustrates a MINLP algorithm configured for self-optimization in accordance with the subject matter presented herein;

FIG. 4 illustrates an automated continuous crystallization platform in accordance with the subject matter presented herein;

FIG. 5 illustrates a PATs integrated interface in accordance with the subject matter presented herein;

FIG. 6 illustrates another PATs integrated interface in accordance with the subject matter presented herein;

FIG. 7 illustrates yet another PATs integrated interface in accordance with the subject matter presented herein;

FIG. 8A, FIG. 8B and FIG. 8C illustrate some results of self-optimization of continuous crystallization of API in accordance with the subject matter presented herein; and

FIG. 9 illustrates a flowchart of an exemplary machine learning algorithm for automation in accordance with the subject matter presented herein.

### DETAILED DESCRIPTION OF THE INVENTION

The subject matter of the present disclosure is described herein with specificity with the help of different aspects to meet statutory requirements. However, the description itself is not intended to limit the scope of this patent. The claimed subject matter might be embodied in other ways, to include different steps or combinations of steps similar to the ones described in this present disclosure, in conjunction with other present or future technologies. Moreover, although the terms “step” and/or “block” may be used herein to connote different elements of methods employed, the terms should not be interpreted as implying any particular order among or between various steps disclosed herein, unless and except when the order of individual steps is explicitly stated. Each method described herein may comprise a computing process that may be performed using any combination of a hardware, firmware, and/or software. For instance, various functions may be carried out by a processor executing instructions stored in a computer memory. The methods may also be embodied as computer-useable instructions stored on computer storage media. The methods may be provided by a stand-alone application, a service or a hosted service (stand-alone or in combination with another hosted service), or a plug-in to another product, to name a few.

Aspects and embodiments of the present disclosure relate to combinations of a custom/in-house, automated continuous crystallization system with a self-optimization engine. The subject matter presented herein combines traditional, off-the-shelf continuous crystallization equipment with a custom-built crystallization control and data acquisition system, capable of integrating several input signals and automatically adjusting the process parameters in response to those inputs. An exemplary control system presented herein can combine mixed-integer nonlinear programming (MINLP), adaptive response surface methodology (ARSM) and machine learning (ML)/Artificial Intelligence (AI) approaches to determine the smallest set of experiments needed to determine the optimal operating parameters for the crystallization process. A control system may automatically executes this set of experiments, gathering data and utilizes ML/AI to determine the relationship between process parameters (including process temperature, sonication power, residence time, and antisolvent addition profile) and process and quality outcomes (including process yield, product purity, particle size, and particle shape). With these relationships known, the subject matter presented herein can use ML/AI algorithm or methods to predict the process parameters which will optimize the desired output variable, for example, process yield. The subject matter presented herein can enable one to automatically execute the additional experiment with optimized parameters and determine the output. Furthermore, the algorithms presented herein may be configured to compare the predicted optimum to the measured outcomes, making further adjustments and executing additional experiments until a true, global optimum for the desired output is achieved.

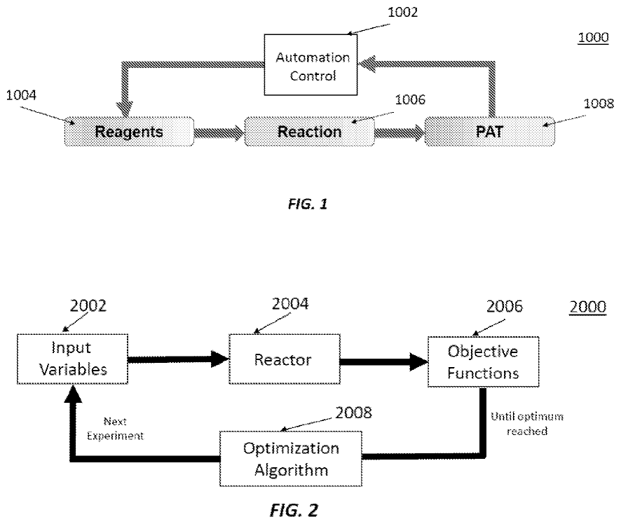

As illustrated in FIG. 1, an artificial intelligence (AI) driven autonomous self-optimization platform for continuous processes 1000 may include an automation control unit 1002 configured to direct an automated self-optimization of continuous crystallization process. In some embodiments, this automation control unit 1002 may be a LabVIEW™ Virtual Instrument (VI) automation software, operating from a computer or a server, configured for the purpose of on-demand automated self-optimization of continuous crystallization. In practice, this control unit 1002 may require only minimal human intervention, relieving expert scientists of manual tasks so that they may focus on new ideas. Furthermore, the control unit 1002 may be in communication with a reagents unit 1004, the reagents unit 1004 configured to provide reagents to a reaction unit 1006. In some embodiments, the reagents unit 1004 may include a feed stream or a reagent platform, and may include tools or instruments such as VICI pumps, Masterflex pumps, syringes, Ismatec pumps and Asia-syrris systems. In some embodiments, the reaction unit 1006 may include plug-and-play reactors and continuous crystallizers, and may consists of instruments such as Corning reactors, mixed suspension-mixed product removal crystallizers (MSMPR), plug flow reactors (PFR) and Chemtrix Protrix Reactors. Still further, the process may also include a process analytical technology (PAT) unit 1008 in communication with the reaction unit 1006 and the automation control unit 1002. The PAT unit 1008 may include instruments such as a Focused Beam Reflectance Measurement (FBRM), EasyViewer™, Blaze Metrics imaging probes, and Mettler ReactIR™ spectroscopy within this environment for feedback optimization, data visualization, and real time process understanding to the automation unit 1000.

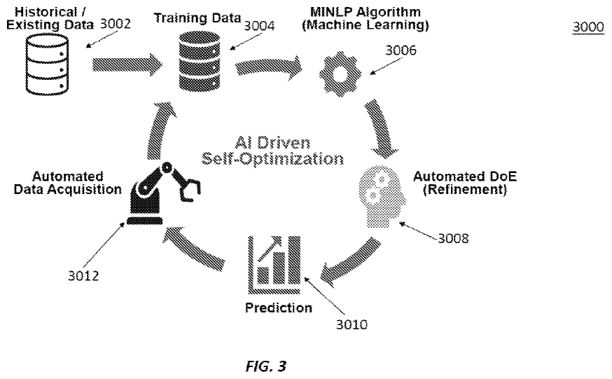

In practice, referring now to FIG. 2, an optimization algorithm setup 2000 may be adopted to optimization the crystallization process. In some embodiments, the setup 2000 may use an optimization algorithm 2008 to control the input variables 2002 to be used in a reactor 2004, and objective functions 2006 may be measured or generated, and the optimization algorithm may collect such objective functions 2006 to optimization the crystallization process.

In practice, a variety of algorithms may be adopted as the optimization algorithm 2008 as illustrated in FIG. 2. For example, a Bayesian-Dragonfly (Python™) algorithm that's capable of processing continuous variables and discrete variables, and can handle multi-objectives can be used herein. The Bayesian algorithm also offers the advantage of Pareto front or trade-off curve generation. In some embodiments, a stable noisy optimization by branch and fit (SNOBFIT) or a Nelder Mead Simplex algorithm may be used to process continuous variables, where derivative-free black-boxes may be generated. In another embodiment, a Mixed-Interger Non-Linear Programing (MINLP) algorithm capable of process continuous variables and discrete variables may be adopted, where the MINLP algorithm is capable of providing discrete variable fathoming.

In some embodiments, referring now to FIG. 3, an AI driven self-optimization process 3000 may include firstly providing historical or existing data 3002 to a training data 3004 set configured to train a MINLP algorithm 3006. The MINLP algorithm 3006 can then be used to run automated design or experiments (DoE) 3008 aimed optimized certain output or characteristics of a crystallization process. In some embodiments, the automated DoE 3010 may be analyzed by a machine learning or AI algorithm to provide predictions 3010 or further DoE parameters. Furthermore, automated data acquisition 3012 may be done on the DoE performed to provide data back to the training data 3004 to further optimize the crystallization process. In this configuration, a feedback loop is formed to automatically and continuously optimize the wanted parameters of a crystallization process.

### MINLP Algorithm

In practice, in the absence of a physical model describing the system behavior, it may be possible to approximate continuous variable effects using a response surface methodology (RSM). In this configuration, a fractional or full-factorial design of experiments may be used to generate data, which is then regressed using a simple linear or quadratic model to estimate the relationships between continuous experimental factors and identify optimal experimental regions. To rapidly optimize more complex systems, sequential RSM could be used, which involves constructing a response surface model around a proposed optimum, testing the optimum experimentally, and updating the model iteratively. Further improvement may be offered by coupling sequential RSM with adaptive RSM (ARSM), which splits the experimental space into subregions. Regional optima are compared against a common threshold to determine whether subregions can be disregarded in the optimum search. Convergence of ARSM can be accelerated by using more efficient optimal design of experiments instead of standard designs such as central composite. To solve a mixed-integer nonlinear programming (MINLP) problem with both continuous and discrete variables, sequential ARSM can be integrated with a global search strategy such as branch and bound (B&B).

Thus, the mixed-integer nonlinear programming (MINLP) algorithm is based on optimal design of experiments (DoE) and the ARSM. In an initialization phase, the algorithm can generate a D-optimal experimental design with diversified variable settings to conduct an efficient initial scan of the design space. The results from these initial experiments can be used to fit a quadratic or linear response surface model using least squares regression for the optimization objective (e.g., yield) as a function of the continuous variables for each discrete variable candidate. In each round of the refinement phase, the algorithm generates a G-optimal experiment for each discrete variable candidate where the goal is to minimize the model's uncertainty at the predicted optimum objective function value (yield).

In some embodiments, a single process output (e.g., yield) may be optimized. In some other embodiments, optimization of a set of process objectives, for example, simultaneously optimizing yield while obtaining a desirable particle size and product purity may be achieved. Doing so with a one-factor-at-a-time approach using traditional experimental approaches defies human capability and can require an impossibly large set of experiments. Therefore, in yet another embodiment, the subject matter presented herein may be modified to incorporate multi-objective optimization of the process outcomes so that more than one objective can be reached simultaneously.

In practice, sonic energy may be provided to obtain a desirable particle size at the outlet of the crystallizer. The amount and timing of applying this energy to obtain a desired particle size may be determined by an algorithm that may be AI or machine learning in nature, and sonic energy applied in this way may cause nucleation in the crystallizer the energy is applied to. In another embodiment, one may employ other nucleation devices in addition to sonic energy, including but not limited to a High Shear Rotor-Stator Mill (aka homogenizer, such as an IKA Dispax reactor), a plug-flow or tubular crystallizer, or other device known in the community to provide nucleation. The integration and control of these devices with the subject matter presented herein would provide additional novelty to the system.

The subject matter presented herein is particularly adept when discrete process parameters are employed. In some embodiments, one can allow a computer to choose discrete variables such as the presence of a nucleator or not, solvent system selection, number of reactors in series, and other discrete variables that were chosen by humans in the current instance. In another embodiment, a system in accordance with the subject matter disclosed herein can operate to optimize other process outcomes, such as chiral purity, filtration rate, particle shape (aspect ratio, circularity, etc.), particle flowability or other attributes desirable in secondary processes such as bulk density, compactibility, tablet tensile strength, tablet dissolution rate, etc. In yet another embodiment, the working principles presented herein may be applied to other systems where the combination of automation, the MINLP/ARSM approach and AI/ML optimization could provide benefit, such as liquid-liquid extractions, pervaporation, high throughput automated droplet reactor system, and other flow chemistry applications.

### Automated Self-Optimization of Continuous Flow Crystallization of API

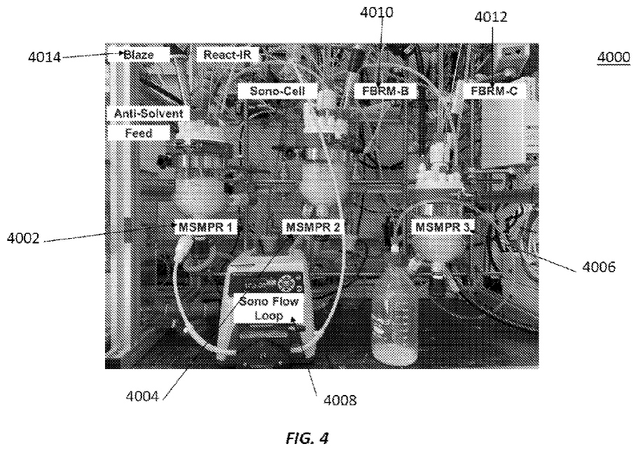

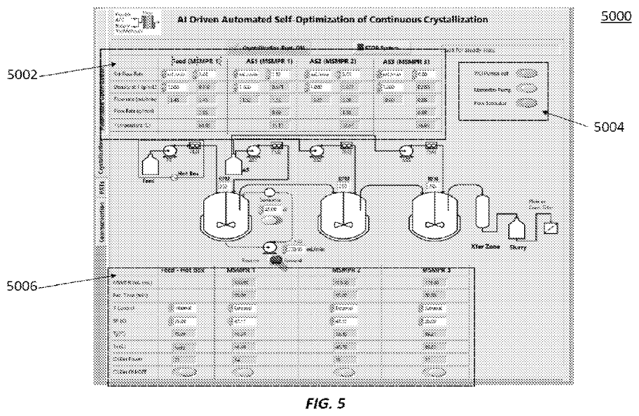

Continuous flow crystallization is an attractive mode of operation, due to its ability to generate consistent product quality while requiring a smaller footprint and lower production costs than its batch counterpart. The subject matter presented herein illustrates a such automated continuous crystallization platform 4000, as shown in FIG. 4. In some embodiments, this crystallization platform 4000 may be a three-stage continuous stirred tank reactor (CSTR) with three crystallizers (e.g., mixed suspension mixed product removal MSPR1 4002, MSPR2 4004, MSPR3 4006) in communication with a sono flow loop 4008. Where PAT instruments such as focused beam reflectance measurement FBRM-B 4010, FBRM-C 4012 and Blaze Metrics imaging probe 4014 may be used to provide real time data reads.

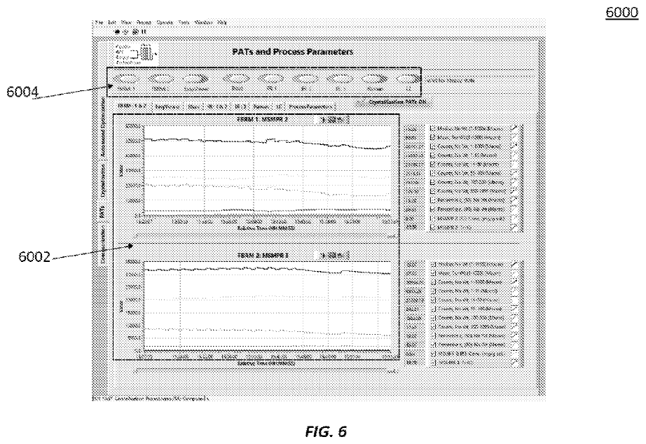

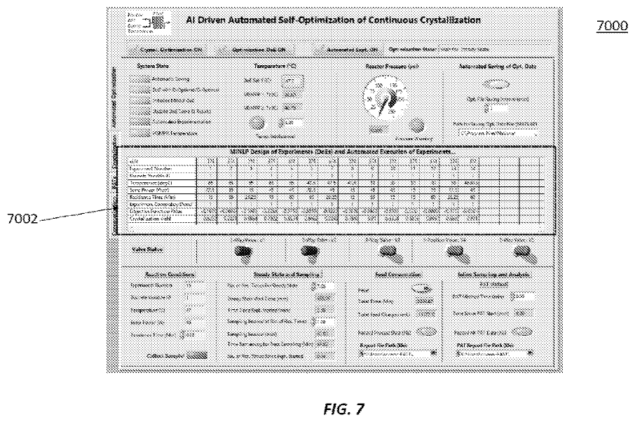

In some embodiments, Artificial intelligence (AI) driven LabVIEW™ Virtual Instrument (VI) automation software may be adopted for the purpose of on-demand automated self-optimization of continuous crystallization, as illustrated in FIG. 5 and FIG. 6. As shown in FIG. 5, the automation software may include an interface 5000 where various hardware controls may be automated. For example, in section 5002 of the interface 5000, control parameters such as flow rate and temperature of the crystallizers MSPR1, MSPR2 and MSPR3 may be controlled and monitored in real time. The interface may also include additional sections (e.g., sections 5004 and 5006) where automated hardware controls may be implemented to include a flow sonicator as the nucleation device, feed pumps, temperature controllers, thermocouples, stirrers, and coriolis mass flowmeters. In addition, an integration of a variety of in-line process analytical technology (PAT) tools via OPCUA, including Focused Beam Reflectance Measurement (FBRM), EasyViewer™, Blaze Metrics imaging probes, and Mettler ReactIR™ spectroscopy within this environment for feedback optimization, data visualization, and real time process understanding.

Referring now to FIG. 6, where another interface 6000 may be configured to provide real-time PAT process understanding. For example, in section 6002 of the interface 6000, real time particle information (e.g., size) from the crystallizers MSPR2 and MSPR3 can be illustrated for providing feedback to the automated self-optimization. And in section 6004 various PAT instruments such as the FBRMs and the Blaze Metrics imaging probe may be turned on or off.

In some embodiments, in order to optimize continuous process variables (e.g., CSTR temperature, residence time, and sonication power), one may utilize a mixed-integer nonlinear programming (MINLP) algorithm. Thereby, the integration of equipment, PAT, and automation control software produces closed-loop systems that, when paired with an optimization protocol, enables automated design of experiments (DoEs) with automated execution of the DOE, ultimately leading to self-optimization of continuous crystallization processes. This autonomous self-optimization platform enabled the identification of optimal conditions for continuous crystallization of API, while reducing the amounts of raw materials consumed, compared to a one factor at a time (OFAT) approach.

TABLE 1
Optimization Variables of API Continuous Crystallization

| Optimization Variable | Range | Units |
|---|---|---|
| Temperature | 30-65 | ° C. |
| Residence time | 15-60 | Min |
| Sono Power | 15-45 | Watt |

As illustrated, Table 1 includes some variables to selected for optimization of yield. In one example, the MINLP algorithm generated initial DoE involving 13 experiments. The automation system was used to sequentially perform 13 automated “experiments” specified in D-optimal DoE. Each experiment was run for five reactor residence times in order to obtain the steady state and collect the data of experimental outcome. Yield was calculated by concentration measured on offline LC with an external standard calibration. Online Mettler ReactIR™ was used to monitor concentrations of reagents. Particle size was tracked by FBRM and Blaze Metrics imaging probes. Upon completion of the 13th experiment, the MINLP optimization algorithm can automatically use the yield values to predict process parameters (sono-power, reactor temperature, & residence time) to maximize the yield in experiment #14 (in the G-Optimal DoE). The measured yield from run #14 surpassed the prior best yield by ˜3%, showing the value of self-optimization. As illustrated in FIG. 7, the AI driven automation software may include yet another interface 7000 configured to illustrate the parameters and results from the 14 DoEs. For example, a section 7002 of the interface 7000 may be configured to provide information such as temperature, sono power and crystallization yield. It should be appreciated that after the PAT data has been collected, the processing and storage of such data may be done remotely away from the experimentation, at any location convenient to a user.

In practice, the subject matter presented herein was able to achieve an optimized yield that was 1 to 3% greater than was previously discovered using a one-factor-at-a-time approach. In one embodiment in accordance with the subject matter disclosed herein determined that thirteen experiments were necessary to train the algorithm needed to predict the optimum. In these thirteen experiments, process parameters of sonic power, residence time, and reactor temperature were varied while collecting the concentration in solution to determine the process yield. The system automatically varied the process parameters for the thirteen experiments with minimal human intervention to refill feed solutions, remove waste, and take manual samples to determine the process yield (all of which can be automatic, the latter will soon be automated with additional work, using online Process Analytical Technology signals). Yield data from the thirteen experiments was used to automatically train the ML/AI algorithm about the relationship between process parameters (sono power, temperature, and residence time) and process yield.

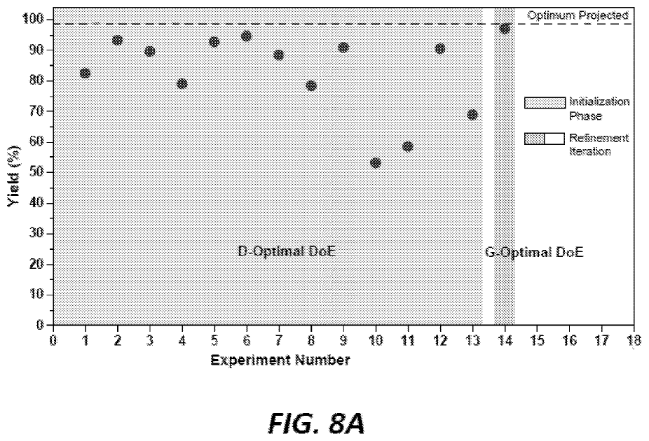

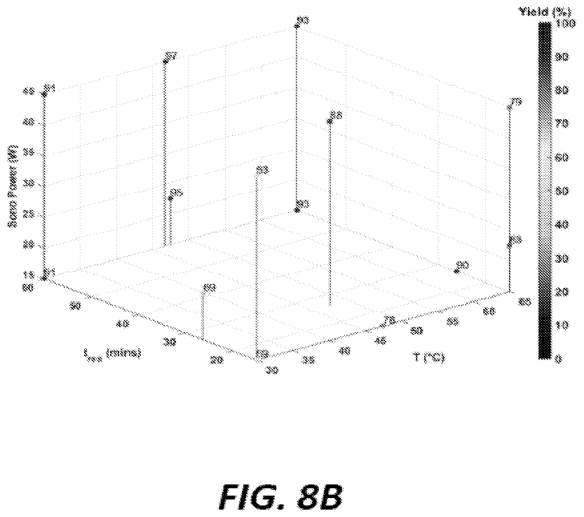

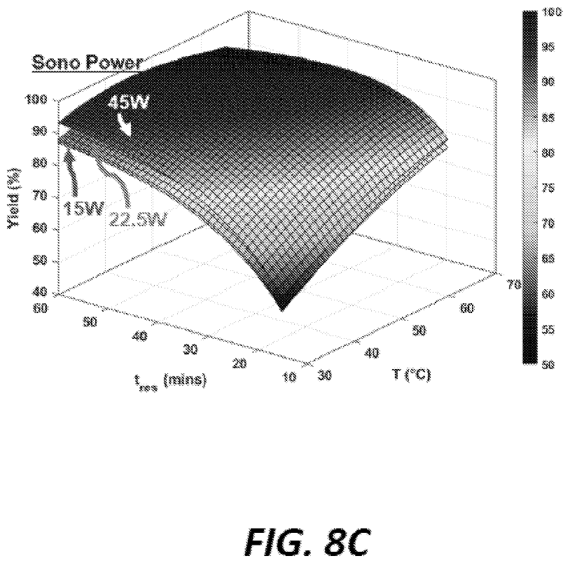

After conducting the thirteen training experiments, the system can automatically determine the process parameters necessary for an optimal yield and began conducting experiment fourteen to determine the yield from the predicted-to-be-optimal process parameters. In one example, a 14th experiment achieved a yield of 95-97%, which was approximately 1 to 3% higher than achieved in the training set and prior experimentation. The system can choose a slightly lower reactor temperature than humans chose, a higher sonic power than humans chose, and the same residence time that humans chose. These choices could later be scientifically rationalized why the yield would be greater because of those choices. FIG. 8A illustrates crystallization yield vs. experiment number including the initialization phase (D-optimal DoE) and refinement iteration (G-optimal); FIG. 8B is a 3D plot of continuous crystallization experimental conditions and yields; and FIG. 8C illustrates a surface plot of predicted yields at different sono power.

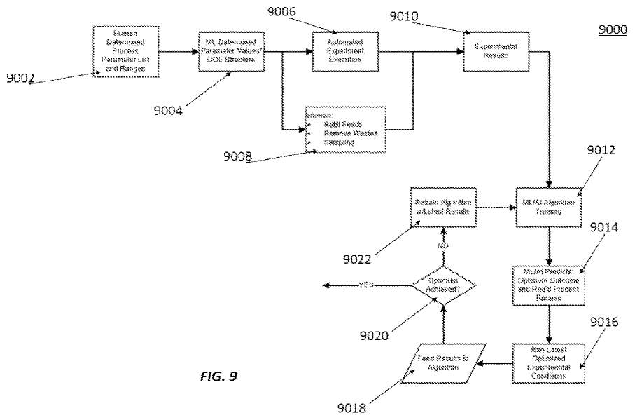

Referring now to FIG. 9, where a process 9000 is illustrated in accordance with the subject matter presented herein. Process 9000 shows a flow chart of an automated optimization process where firstly at step 9002 humanly determined process parameters and ranges may be provided to a machine learning ML algorithm or AI driven automation software. Subsequently, in step 9004, the ML algorithm or AI driving software may determine the parameter values and ranges for a set of DoE experiments. Next in step 9006 automated experiment execution may be carried out while concurrently in a step 9008 human input such as refill feeds, remove wastes, and sampling may be provided. Next in 9010 experimental results may be collected and provided to a ML or AI algorithm for training (i.e., step 9012). Subsequently, in step 9014, the ML or AI algorithm may make predictions about the optimum outcome and required process parameters, and then in step 9016 run latest optimized experimental conditions. Then in step 9018 feed the results to the algorithms. And in step 9020 a determination is made if an optimized result is achieved here, if not, then a step 9022 where a retrain of the algorithms with the latest results may be performed, and subsequently steps 9012 to 9020 may be repeated. It should be appreciated that only steps 9002 and 9008 may need human intervention, where the rest of the process including steps 9004, 9006, 9010, 9012, 9014, 9016, 9018, 9020 and 9022 are all automated actions.

Many different arrangements of the various components depicted, as well as components not shown, are possible without departing from the scope of the claims below. Embodiments of the disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. A method for performing crystallization comprising:
utilizing a software algorithm; and
performing a crystallization process using the software algorithm.

2. The method of claim 1, wherein the software algorithm is a machine learning algorithm.

3. The method of claim 1, wherein the software algorithm is an artificial intelligence algorithm.

4. The method of claim 1, wherein the software algorithm is a mixed-integer nonlinear programming (MINLP).

5. The method of claim 4, wherein the MINLP algorithm is based on optimal design of experiments (DoE) and adaptive response surface methodology (ARSM).

6. The method of claim 1, wherein the crystallization process comprises optimizing process temperature.

7. The method of claim 1, wherein the crystallization process comprises optimizing sonication power.

8. The method of claim 1, wherein the crystallization process comprises optimizing residence time.

9. The method of claim 1, wherein the crystallization process comprises optimizing antisolvent addition profile.

10. The method of claim 1, wherein the crystallization process comprises optimizing process yield.

11. The method of claim 1, wherein the crystallization process comprises optimizing product purity.

12. The method of claim 1, wherein the crystallization process comprises optimizing particle size.

13. The method of claim 1, wherein the crystallization process comprises optimizing particle shape.

14. A crystallization system comprising:
means to utilizing a software algorithm;
means to perform a crystallization process using the software algorithm;
means to collect data from the crystallization process; and
means to perform additional crystallization process using the collected data.

15. The method of claim 14, wherein the software algorithm is a machine learning algorithm.

16. The method of claim 14, wherein the software algorithm is an artificial intelligence algorithm.

17. The method of claim 14, wherein the software algorithm is a mixed-integer nonlinear programming (MINLP).

18. The method of claim 17, wherein the MINLP algorithm is based on optimal design of experiments (DoE) and adaptive response surface methodology (ARSM).

19. The method of claim 14, wherein the crystallization process comprises optimizing process temperature.

20. The method of claim 1, wherein the crystallization process comprises optimizing sonication power.
